(19) United States
(12) Patent Application Publication
(10) Pub. No.: US 2018/0212440 A1
(43) Pub. Date: Jul. 26, 2018

(54) RECONFIGURABLE CAPACITIVE ENERGY STORAGE DEVICE, POWER SUPPLY SYSTEM AND ELECTRIC VEHICLE INCORPORATING SAID DEVICE

(71) Applicant: BLUE SOLUTIONS, Ergue Gaberic (FR)

(72) Inventor: Jean-Michel DEPOND, Quimper (FR)

(73) Assignee: Blue Solutions, Ergue Gaberic (FR)

(21) Appl. No.: 15/745,971

(22) PCT Filed: Jul. 20, 2016
(86) PCT No.: PCT/EP2016/067319

§ 371 Date: Jan. 18, 2018

(30) Foreign Application Priority Data
Jul. 23, 2015 (FR) 1556994

(51) Int. Cl. H02J 7/00; B60L 11/18; H01G 11/10

(52) U.S. Cl. CPC H02J 7/0013; H02J 7/345; H01G 11/10; B60L 11/1809

(57) ABSTRACT

The present disclosure is within the field of capacitive electrical energy storage, to supply electric or hybrid vehicles. It relates to a reconfigurable electrical energy storage device, wherein the internal connections between the different energy storage modules is modifiable.

The device includes:
M×N storage modules, where M and N are strictly positive natural numbers, each storage module storing electrical energy by capacitive effect between a negative terminal and a positive terminal;
contactors arranged to order to make it possible to connect by their terminals M₁×Nᵢ storage modules, in different combinations, each combination denoted by an index i including Mᵢ branches connected in parallel, each branch including Nᵢ storage modules connected in series, where Mᵢ×Nᵢ≤M×N; and
positive and negative electrical connection terminals to which are capable of being connected, in each combination, the ends of the branches connected in parallel.

### TECHNICAL FIELD

The invention is situated within the field of electrical energy storage, in particular energy storage in capacitive form. It applies in particular to the power supply for autonomous electric vehicles. More specifically, the invention relates to an energy storage device by capacitive effect, a supply system incorporating this device, and an electric or hybrid vehicle incorporating this device or this power supply system.

### STATE OF THE ART

A machine or an installation utilizing electrical energy for its operation must often adapt the nature of the energy supplied thereto. This is the case in particular when the energy is supplied in mechanical form (for example by a flywheel), or in an electrical form but with voltage properties and signal form (for example variable or direct voltage) that are unsuitable. Within the field of the power supply for autonomous electric vehicles, energy storage is typically carried out in the form of an electrochemical charge transfer device. This essentially involves electric cells (or accumulators) and fuel cells. These electrochemical energy storage devices deliver a direct voltage, while very often the electrical machines in the vehicles require alternating voltage. For this reason, it is common to combine an energy conversion device with these electrochemical energy storage devices. The energy conversion device can also adapt the voltage range delivered by the electrochemical energy storage device to the voltage or the voltage range of the power supply of the electrical machine in question. In order to optimize the use of the energy stored by the electrochemical energy storage device, the energy conversion device is highly optimized with respect thereto. In particular, the input voltage range of the energy conversion device is adapted to the output voltage range of the storage device, with the aim of minimizing the losses by Joule effect and increasing the energy efficiency. This adaptation involves in practice pairing the energy conversion device with the energy storage device, without the possibility of replacing the storage device by another having different characteristics, unless to the detriment of the energy efficiency.

In recent years, energy storage devices in capacitive form have developed rapidly. In particular, from now on, supercapacitors will have a sufficient weight-to-capacity ratio to make it possible to envisage their use as a main energy source for the propulsion of electric vehicles. However, simply replacing an electrochemical energy storage device with a supercapacitor or a plurality of supercapacitors would lead to severe deterioration in performance values. In fact, an electrochemical energy storage device works over a relatively narrow voltage range, while a supercapacitor works over a relatively wide voltage range. An electrochemical energy storage device typically operates over a voltage range of U_{ref}±15%, where U_{ref} defines the nominal voltage value. Practically 100% of the useful energy of an electrochemical energy storage device is available over a voltage range [⅔ U_{ref}; U_{ref}]. In contrast, over an equivalent voltage range [⅔ Uₙ; Uₙ], with Uₙ the nominal value of the voltage in the charged state, a supercapacitor only gives access to approximately 50% of its useful energy. Thus, over one and the same voltage range and for the same energy initially stored, a supercapacitor delivers two times less energy than an electric battery or a fuel cell.

Coupling a supercapacitor with an energy conversion device does not allow the stored energy to be efficiently recovered for voltage values below ⅔ Uₙ. In fact, over a voltage range [⅔ Uₘₐₓ; Uₘₐₓ], an energy conversion device generally has an efficiency of the order of 98%. But this efficiency can fall significantly below 90% for voltages of less than ⅔ Uₘₐₓ.

Moreover, energy conversion devices generally operate at constant power. In the case of an electrochemical energy storage device, the voltage at the terminals of the device does not vary significantly, and therefore the losses by Joule effect, associated with power requirement, remain limited. In the case of a supercapacitor, the voltage varies significantly during operation, and when the voltage drops, the current must compensate for this drop, causing an increase in the losses by Joule effect.

### DISCLOSURE OF THE INVENTION

A purpose of the invention is in particular to overcome all or part of the aforementioned drawbacks. In particular, a purpose of the invention is to propose an electrical energy storage device by capacitive effect that makes it possible to optimize the use of the stored energy.

A further purpose of the invention is to propose an energy storage device by capacitive effect that makes it possible to replace an electrochemical energy storage device effectively.

The energy storage device by capacitive effect must make it possible in particular, when it replaces an electrochemical energy storage device coupled with an energy converter, to use this energy converter within a conversion range having relatively high efficiency, typically greater than 95%.

The energy storage device by capacitive effect according to the invention is based on using several basic energy storage modules, and reconfiguring the connection between these modules so that the energy storage device has over time, at its terminals, a voltage comprised within a desired voltage range.

More specifically, the purpose of the invention is a reconfigurable electrical energy storage device comprising:
M×N storage modules, where M and N are strictly positive natural numbers, each storage module being capable of storing electrical energy by capacitive effect between a negative terminal and a positive terminal,
contactors arranged in order to make it possible to connect by their terminals Mᵢ×Nᵢ storage modules, in different combinations, each combination denoted by an index i comprising Mᵢ branches connected in parallel, each branch comprising Nᵢ storage modules connected in series, where Mᵢ×Nᵢ≤M×N, and
positive (102) and negative (101) electrical connection terminals to which in each combination, the ends of the branches connected in parallel are capable of being connected.

The energy storage modules by capacitive effect are typically supercapacitors or combinations of supercapacitors.

The contactors can be of any type and any technology, provided that they are capable of establishing or interrupting an electrical contact between at least two electrical points. For example, these may be switches, in particular controllable, controllable inverters, or controllable commutators. These contactors can be described as reconfiguration contactors, inasmuch as they make it possible to switch over from one combination of storage modules to another combination.

Despite the greater amplitude of voltage variation at the terminals of an energy storage module by capacitive effect with respect to an electrochemical energy storage device by charge transfer, the reconfigurable energy storage device according to the invention can replace such a device without modifying its electrical environment, and in particular the energy converter. In particular, the reconfigurable device can be arranged in order to have, between the two connection terminals, a voltage capable of varying between a minimum voltage Uₘᵢₙ and a maximum voltage Uₘₐₓ.

Moreover, the reconfigurable device according to the invention has the advantage of optimizing the design of the internal connections of the energy storage device. In fact, energy converters generally work at high power. The lower the voltage at which the energy storage device works, the higher the amperage of the current passing through it, and therefore passing through the energy converter. When the energy storage device by capacitive effect cannot be reconfigured, its internal connections must be dimensioned in order to pass high currents flowing at low voltage. This presupposes the use of relatively high-power connector engineering, with large cross-sections for the passage of current, which ultimately causes additional constraints in terms of weight, volume and cost. In the case of the reconfigurable device according to the invention, a maximum permissible current can be defined, involving changes in the configuration in order to avoid an increase in the current beyond this threshold. The energy converter also benefits from the current limitation, which makes it possible to use smaller cross-sections for the passage of current. Working at a lower current, the energy converters also generally have the advantage of presenting improved energy efficiency.

When the reconfigurable energy storage device according to the invention is associated with an energy converter, the losses by Joule effect can also be reduced. In fact, as these losses are a function of the square of the total current, they are limited when making the energy converter work in a high-voltage range, and thus in a relatively low current range.

The reconfigurable energy storage device according to the invention can be arranged in order to be within a safety configuration, i.e. a configuration in which the positive electrical connection terminal and the negative electrical connection terminal are not linked together by a storage module. In other words, each branch of storage modules is isolated from at least one of the positive and negative connection terminals. No current can then flow from the negative electrical connection terminal to the positive electrical connection terminal. The safety configuration can be useful in particular so as to allow an operator to carry out maintenance tasks by limiting the risk of electric shock.

The safety configuration can for example be obtained by providing the reconfigurable electrical energy storage device according to the invention with a safety contactor arranged in order to be able to adopt an isolation position, in which, for at least one combination of the storage modules, each branch is isolated from the positive electrical connection terminal and/or from the negative electrical connection terminal. The safety contactor is for example placed between the positive ends of the branches connected in parallel and the positive electrical connection terminal or between the negative ends of the branches connected in parallel and the negative electrical connection terminal. Of course, the reconfigurable electrical energy storage device according to the invention can comprise several safety contactors, each being capable of connecting or isolating the positive electrical connection terminal, or the negative electrical connection terminal, from the end of one or more branches.

The safety contactor can be a manual or controlled contactor. If necessary, it can be controlled by the same control unit as the one driving the contactors arranged in order to produce the different combinations of storage modules.

The safety configuration can also be obtained without introducing any specific safety contactor. The reconfiguration contactors, arranged in order to make it possible to connect the storage modules in different combinations, can in fact be driven in such a way as to isolate each branch of the positive electrical connection terminal, and/or the negative electrical connection terminal.

According to a particular embodiment, the M×N storage modules have one and the same maximum voltage U_{mod-max} at their terminals and one and the same capacitance. The reconfiguration of the storage modules according to different combinations is then facilitated. In particular, if all the storage modules were identically charged in previous combinations, then in any new combination where each branch comprises an identical number of storage modules, the branches have one and the same voltage at their terminals and can therefore be connected in parallel without involving energy transfer between the storage modules.

With the aim of charging the different storage modules identically, the contactors can be arranged so that, for each combination, the product Mᵢ×Nᵢ of the number of branches times the number of storage modules in each branch is equal to the number M×N of storage modules in the reconfigurable electrical energy storage device.

To the extent that approximately 90% of the energy of a capacitive storage module can be restored over a voltage range corresponding to two-thirds of the maximum voltage U_{mod-max} at the terminals of this storage module, the contactors can be arranged so that, among the different combinations, the maximum number Nₘₐₓ of storage modules in each branch is less than or equal to three times the minimum number Nₘᵢₙ of storage modules in each branch.

In order to manage the reconfiguration of a combination of storage modules to another combination, the reconfigurable device can also comprise:
a measurement unit, arranged in order to measure a control voltage between the negative terminal of a first storage module among the M×N storage modules, and the positive terminal of a second storage module among the M×N storage modules, identical to or different from the first storage module, and
a control unit, arranged in order to drive the controlled contactors as a function of the control voltage.

According to a first embodiment variant, the control unit is arranged so that, when the control voltage becomes less than a minimum voltage Uₘᵢₙ, or greater than a maximum voltage Uₘₐₓ, the controlled contactors are driven in order to connect the storage modules in a new combination, in which the control voltage is comprised between the minimum voltage Uₘᵢₙ, and the maximum voltage Uₘₐₓ.

According to a second variant embodiment, the control unit is arranged so that:
when the control voltage becomes less than a minimum discharge voltage U_{dech}, the controlled contactors are driven in order to connect the storage modules in a new combination, in which the control voltage is comprised between a minimum operating voltage Uₘᵢₙ, and a maximum operating voltage Uₘₐₓ, where U_{dech}<Uₘᵢₙ<Uₘₐₓ, and/or
when the control voltage becomes greater than a maximum load voltage U_{ch}, the controlled contactors are driven in order to connect the storage modules in a new combination, in which the control voltage is comprised between a minimum operating voltage Uₘᵢₙ, and a maximum operating voltage Uₘₐₓ, where Uₘᵢₙ<Uₘₐₓ<U_{ch}.

The measurement unit is for example arranged in order to measure the control voltage between the positive and negative electrical terminals of the configurable device, i.e. between the ends of the branches connected in parallel.

The control unit and the storage modules can be arranged such that the voltage difference ΔUₘₐₓ between the maximum operating voltage Uₘₐₓ and the minimum operating voltage Uₘᵢₙ is greater than or equal to the maximum voltage U_{mod-max} at the terminals of a storage module. When all the storage modules have one and the same maximum voltage U_{mod-max} at their terminals and one and the same capacitance, this condition makes it possible to ensure that the addition or the removal of a storage module in each branch brings the voltage observed between the ends of the branches between the minimum operating voltage Uₘᵢₙ and the maximum operating voltage Uₘₐₓ.

The control unit and the storage modules can also be arranged so that the number of storage modules capable of being added or removed in each branch during switch-over from one combination to a next combination is less than or equal to a maximum number nₘₐₓ, determined so as to satisfy the relationship:

nₘₐₓ U_{mod-max}≤ΔUₘₐₓ≤(nₘₐₓ+1) U_{mod-max}

where ΔUₘₐₓ is the voltage difference between the maximum operating voltage Uₘₐₓ and the minimum operating voltage Uₘᵢₙ between the positive and negative terminals of the reconfigurable device.

A subject of the invention is also a power supply system capable of supplying power for a load, such as a power train of an electric or hybrid vehicle, and being recharged by a recharging station. The system comprises:
a reconfigurable electrical energy storage device such as previously described,
a third electrical connection terminal and a fourth electrical connection terminal, capable of being connected to the load or to the recharging station, and
an energy converter capable of connecting the first and second electrical connection terminals to the third and the fourth electrical connection terminals, and arranged in order to adapt the form of the voltage between the first and second electrical connection terminals to the form of the voltage between the third and the fourth electrical connection terminals.

Advantageously, the power supply system comprises a reconfigurable energy storage device in which the control unit is arranged so that, within the voltage range comprised between the minimum operating voltage Uₘᵢₙ and the maximum operating voltage Uₘₐₓ, the energy converter has an efficiency greater than or equal to 90% or 95%.

According to a first variant, the supply system also comprises:
an electrochemical energy storage device by charge transfer, capable of storing electrical energy between a fifth electrical connection terminal and a sixth electrical connection terminal, and
a controlled switch arranged in order to connect the third and fourth electrical connection terminals to the first and second electrical connection terminals of the reconfigurable electrical energy storage device or to the fifth and sixth electrical connection terminals of the electrochemical energy storage device by charge transfer.

According to a second variant, the power supply system also comprises:
a generator unit, capable of delivering electrical energy between a seventh electrical connection terminal and an eighth electrical connection terminal, and
a controlled switch arranged in order to connect the third and fourth electrical connection terminals to the first and second electrical connection terminals of the reconfigurable electrical energy storage device or to the seventh and eighth electrical connection terminals of the generator unit.

The first and second variants can be combined in order to have available two additional energy sources as well as the reconfigurable device. Thus, according to a third variant embodiment, the controlled switch is arranged in order to connect the third and fourth electrical connection terminals to the first and second electrical connection terminals of the reconfigurable electrical energy storage device, to the fifth and sixth electrical connection terminals of the electrochemical energy storage device by charge transfer or to the seventh and eighth electrical connection terminals of the generator unit.

Finally, a subject of the invention is a vehicle comprising an electric power train and either a reconfigurable energy storage device as previously described, or a power supply system as previously described, the device or the power supply system being arranged in order to supply the power train with electrical energy.

### DESCRIPTION OF THE FIGURES

Other advantages and features of the invention will become apparent on reading the detailed description of implementations and embodiments which are in no way limitative, and the attached drawings, in which:

FIG. 1A shows diagrammatically a first example of a reconfigurable energy storage device according to the invention comprising twelve storage modules;

FIG. 1B shows diagrammatically a variant of the first example of a reconfigurable energy storage device according to the invention;

FIG. 2 shows diagrammatically a second example of a reconfigurable energy storage device according to the invention, incorporating a measurement unit and a control unit;

FIGS. 3A to 3E show different possible combinations of the storage modules of the reconfigurable device in FIG. 1A;

FIG. 4 shows an example of a power supply system comprising the reconfigurable device in FIG. 2, as well as an energy converter.

FIGS. 5A and 5B show an example of sequencing of the switch-over of controlled inverters of the reconfigurable device in FIG. 1A during a reconfiguration between two combinations;

FIG. 6 shows the typical relationship between the useful energy accessible during a discharge of a capacitive element as a function of the voltage at its terminals;

FIGS. 7A to 7E show different possible combinations for a reconfigurable energy storage device comprising sixteen storage modules;

FIG. 8 shows a power supply system comprising a reconfigurable energy storage device according to the invention and an electric battery.

### DESCRIPTION OF EMBODIMENTS

As the embodiments described hereinafter are in no way limitative, variants of the invention can in particular be envisaged that comprise only a selection of the characteristics described below in isolation from the other characteristics described, (even if this selection is isolated within a sentence comprising these other characteristics) if this selection of characteristics is sufficient to confer a technical advantage or to differentiate the invention from the prior art. This selection comprises at least one preferably functional characteristic without structural details, or with only a part of the structural details if this part alone is sufficient to confer a technical advantage or to differentiate the invention with respect to the prior art.

In the present invention, by “energy storage module by capacitive effect”, or more simply “storage module” is meant any assembly of one or more electrical capacitors connected together in such a way as to have two connection terminals, one described as negative terminal and the other as positive terminal. A capacitor is defined as any electrical or electronic component having two conductive plates separated by a dielectric and capable of storing opposite electrical charges on its plates. The plates are capable of being connected to elements of an electrical circuit via the two connection terminals. In a storage module, the capacitors can be connected together in any type of combination. Preferably, all the capacitors of a storage module are of the same type (for example electrolytic or with insulation). Advantageously, they have the same properties in terms of capacitance, maximum voltage and internal resistance. The storage module is intended to store a relatively large quantity of electrical energy. By way of illustration, each storage module can store a quantity of electrical energy of the order of a kilowatt-hour, for example comprised between 0.1 kWh and 10 kWh. For an energy storage application, a capacitor is commonly called a “supercapacitor”. Most of the existing supercapacitors are based on the technology called “electrochemical double layer”. According to this technology, the supercapacitor comprises two porous electrodes containing for example activated carbon and soaked in an ionic solution.

It is noted that a capacitor is characterized mainly by its capacitance C and the energy E stored by the capacitor is defined by the relationship:

E=½CU²

where U is the voltage at the terminals of the capacitor that is considered ideal, i.e. it has in particular no internal resistance. A capacitor can function over a voltage range defined between zero voltage (U=0) and a maximum voltage Uₘₐₓ. It can thus potentially store and deliver a quantity of energy equal to:

E=½CU²ₘₐₓ

According to the present description, a contactor is defined as any electrical device capable of adopting at least two positions, namely a first position, called contact position, in which it establishes an electrical contact between two points such as connection terminals, and a second position, called isolation position, in which it electrically isolates these two points from one another. The contactor can adopt a greater number of positions. It can also manage the connection between three points, one of the points being able alternatively to connect to one of the two other points. Generally this is referred to as an inverter. The contactor can be actuated manually or can be controlled. In the latter case, it is described as a “control contactor”. A control contactor can be produced according to different technologies. In particular, it can be produced in the form of a transistor, or an electrical circuit comprising at least one transistor.

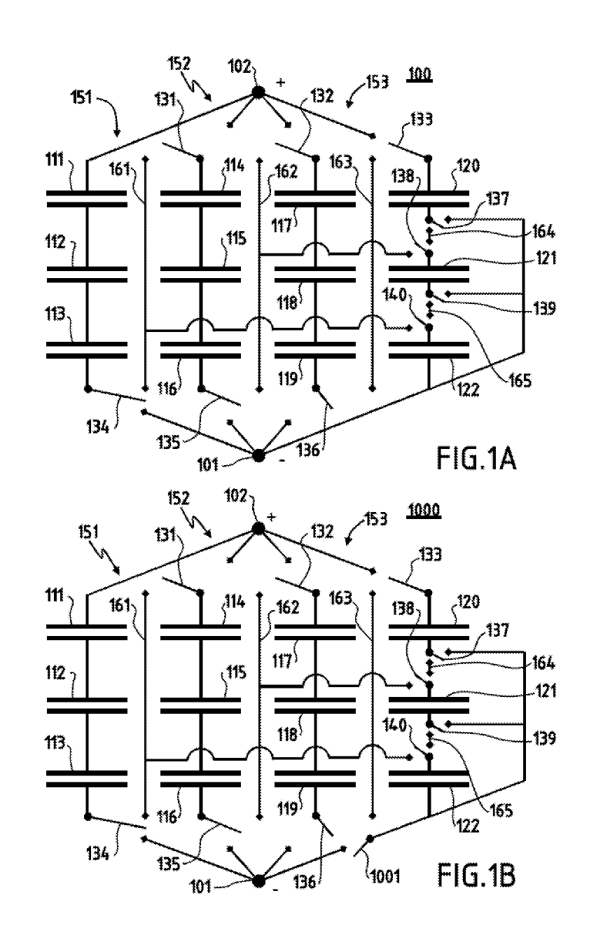

FIG. 1A shows diagrammatically an example of a reconfigurable energy storage device according to the invention. In this embodiment, the device 100 comprises a negative connection terminal 101, a positive connection terminal 102, twelve storage modules 111-122, and ten controlled inverters 131-140. In the interests of simplicity, the storage modules are denoted individually or collectively by the reference 110, and the controlled inverters are denoted individually or collectively by the reference 130.

The storage modules 110 all have the same electrical properties, plus or minus a few percentage points due to design variance and aging of the electrical components. In particular, the storage modules 110 have one and the same nominal voltage U_{mod-max}, and one and the same capacitance C. Thus they are each capable of storing one and the same quantity of electrical energy. The storage modules 111, 112 and 113 are connected in series in order to form a first branch 151. The storage modules 114, 115 and 116 are connected in series in order to form a second branch 152. The storage modules 117, 118 and 119 are connected in series in order to form a third branch 153. The connection of the storage modules 111-119 is permanent within each branch 151-153. In other words, the device 100 does not have means making it possible to connect the storage modules 111-119 other than by combinations of three in series. The three remaining modules 120-122 are on the other hand not connected together permanently. It should be noted that the storage modules 110 are shown in FIG. 1A in an arrangement of 4 columns by 3 rows. The number of storage modules can thus be defined by the product 4×3 or, more generally, M×N, with M=4 and N=3. However, it is important to emphasize that only the total number of storage modules is important in the context of the invention, their arrangement being unimportant, provided that the desired connections (whether permanent or not) between the storage modules are possible.

The device 100 also comprises five internal connection points 161, 162, 163, 164, 165. These connection points are described as internal inasmuch as they are not intended to be connected outside the reconfigurable energy storage device 100 with a view to delivering the energy stored in the storage modules 110, or receiving energy to be stored in these modules. Nevertheless, the connection points 161-165 can be made accessible from outside the device 100, for example so as to serve as measurement points in order to monitor a voltage. The connection points 161-165 have the function in particular of simplifying the production of the reconfigurable energy storage device 100 by forming points capable of being connected to several elements (storage modules and controlled contactors) of the device 100. The connection points 161-163 also have the function of making certain connection terminals (of the device 100 and/or of the storage modules 110) physically closer together. Thus they take the form of electric cables, for example. In the case in question, the connection point 161 brings the negative terminal of the storage module 113 closer to the positive terminal of the storage module 114, and to the positive terminal of the storage module 122; the connection point 162 brings the negative terminal of the storage module 116 closer to the positive terminal of the storage module 117, and to the positive terminal of the storage module 121; and the connection point 163 brings the negative terminal of the storage module 119 closer to the positive terminal of the storage module 120. Bringing certain connection terminals closer together makes it possible to use controlled inverters, instead of simple controlled switches. The number of controlled contactors can thus be reduced, which facilitates the production of the reconfigurable electrical energy storage device and increases its reliability.

The controlled inverter 131 is arranged in order to connect the positive terminal of the storage module 114 either to the connection point 161, or to the positive connection terminal 102 of the device 100. The controlled inverter 132 is arranged in order to connect the positive terminal of the storage module 117 either to the connection point 162, or to the positive connection terminal 102 of the device 100. The controlled inverter 133 is arranged in order to connect the positive terminal of the storage module 120 either to the connection point 163, or to the positive connection terminal 102 of the device 100. The controlled inverter 134 is arranged in order to connect the negative terminal of the storage module 113 either to the connection point 161, or to the positive connection terminal 101 of the device 100. The controlled inverter 135 is arranged in order to connect the negative terminal of the storage module 116 either to the connection point 162, or to the negative connection terminal 101 of the device 100. The controlled inverter 136 is arranged in order to connect the negative terminal of the storage module 119 either to the connection point 163, or to the negative connection terminal 101 of the device 100. The controlled inverter 137 is arranged in order to connect the negative terminal of the storage module 120 either to the connection point 164, or to the negative connection terminal 101 of the device 100. The controlled inverter 138 is arranged in order to connect the positive terminal of the storage module 121 either to the connection point 162, or to the connection point 164. The controlled inverter 139 is arranged in order to connect the negative terminal of the storage module 121 either to the connection point 165, or to the negative connection terminal 101 of the device 100. The controlled inverter 140 is arranged in order to connect the positive terminal of the storage module 122 either to the connection point 161, or to the connection point 165.

On reading the following description relating to the connections effectively established within the device 100, a person skilled in the art will know that other configurations than the one described with reference to FIG. 1A are possible. In particular, the connection points 164 and 165 may be dispensed with. The controlled inverter 137 would then be arranged in order to connect the negative terminal of the storage module 120 either to the positive terminal of the storage module 121, or to the negative connection terminal 101 of the device 100. The controlled inverter 138 may be replaced by a controlled switch arranged in order to connect, or not, the positive terminal of the storage module 121 to the connection point 162. Similarly, the controlled inverter 139 would then be arranged in order to connect the negative terminal of the storage module 121 either to the positive terminal of the storage module 122, or to the negative connection terminal 101 of the device 100. The controlled inverter 140 may be replaced by a controlled switch arranged in order to connect, or not, the positive terminal of the storage module 122 to the connection point 161.

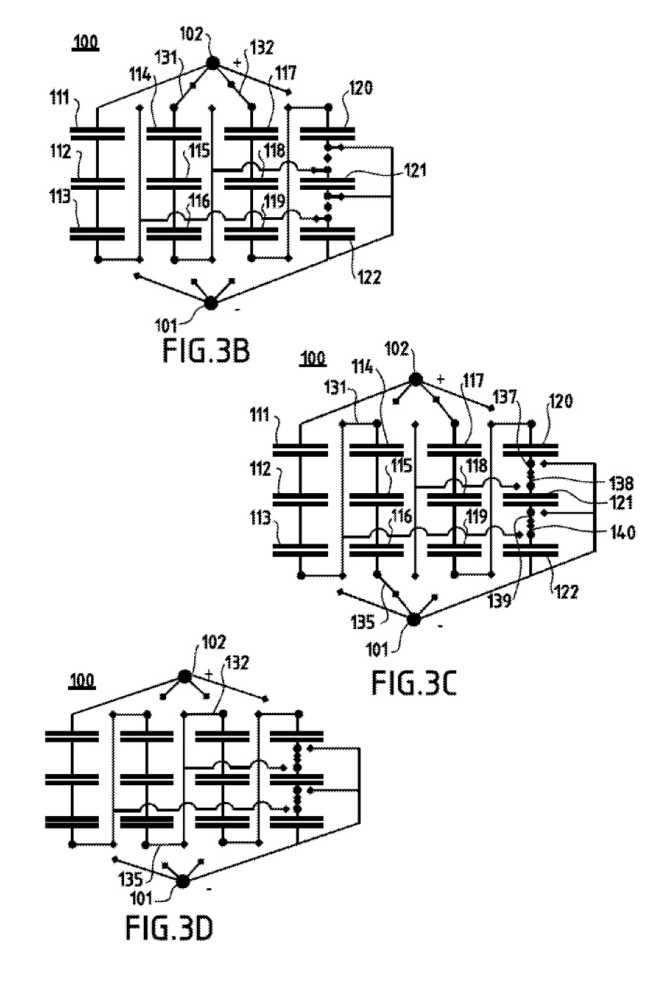

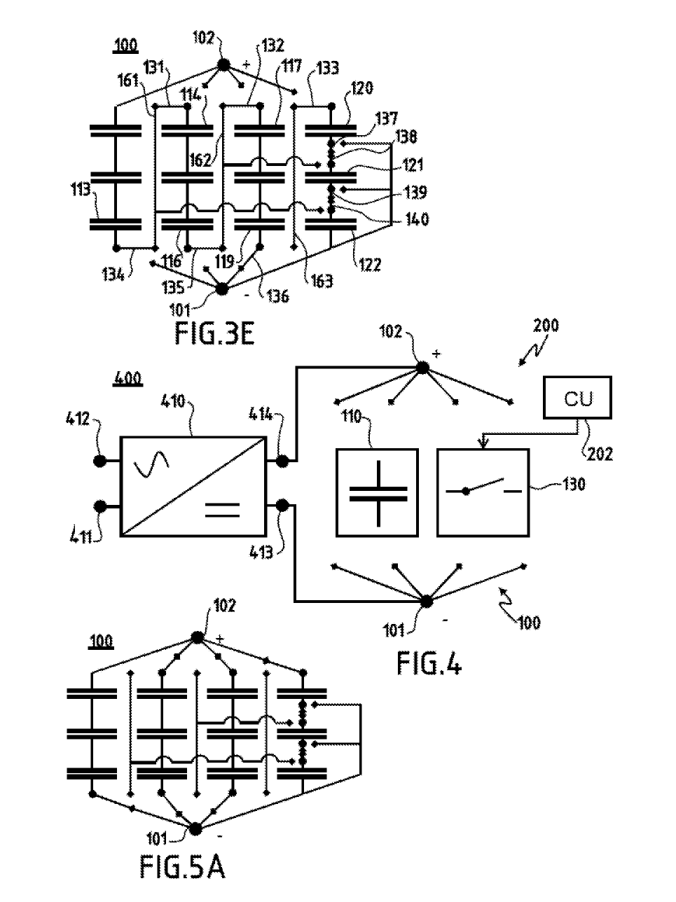

FIG. 1B shows a variant of the example of a reconfigurable energy storage device described with reference to FIG. 1A. In this variant, the device 1000 differs from the device 100 only in that it also includes a switch 1001, called safety switch, arranged in order to adopt either a contact position (closed position) or an isolation position (open position). In the contact position, the safety switch 1001 connects the negative electrical connection terminal 101 to the negative terminal of the storage modules 120, 121 and 122. In the isolation position, it isolates the negative electrical connection terminal 101 from the negative terminal of the storage modules 120, 121 and 122. The safety switch 1001 can typically be a manual switch. Such a switch can thus be opened by an operator prior to a maintenance operation on the device 1000, and closed at the end of the maintenance task. The switch 1001 can also be a controlled switch. In this case, it can be driven by one and the same control unit as the storage modules 111-122, or by a separate control unit. The device 1000 can adopt a safety configuration by driving the controlled inverters 131-140 and by manoeuvring (manually or automatically) the safety switch 1001 so as to isolate each storage module 111-122 of the negative electrical connection terminal 101 and/or of the positive electrical connection terminal 102. According to a first solution, the controlled inverters 131-140 are driven in order to form a first branch formed from the storage modules 111, 112, 113 and 122, a second branch formed from the storage modules 114, 115, 116 and 121, and a third branch formed from the storage modules 117, 118, 119 and 120, according to the configuration described below with reference to FIG. 3B. According to a second solution, the controlled inverters 131-140 are driven in order to form a single branch comprising the assembly of storage modules 111-122 connected in series, according to the configuration described below with reference to FIG. 3D. In each solution, the safety switch 1001 is manoeuvred into the isolation position, so as to break the electrical connection between the negative electrical connection terminal 101 and the positive electrical connection terminal 102.

The reconfigurable energy storage device 100 or 1000 can typically be arranged in order to have at each moment, between its connection terminals 101 and 102, a voltage capable of varying between a minimum voltage Uₘᵢₙ and a maximum voltage Uₘₐₓ, this functional range having an amplitude less than the amplitude of the voltage variation at the terminals of a single storage module 110 between its fully discharged state (U_{mod}=0) and its fully charged state (U_{mod}=U_{mod-max}). The device 100 or 1000 can then also comprise means for controlling the controlled inverters so that the voltage between the connection terminals 101 and 102 remains within this functional range [Uₘₐₓ; Uₘᵢₙ].

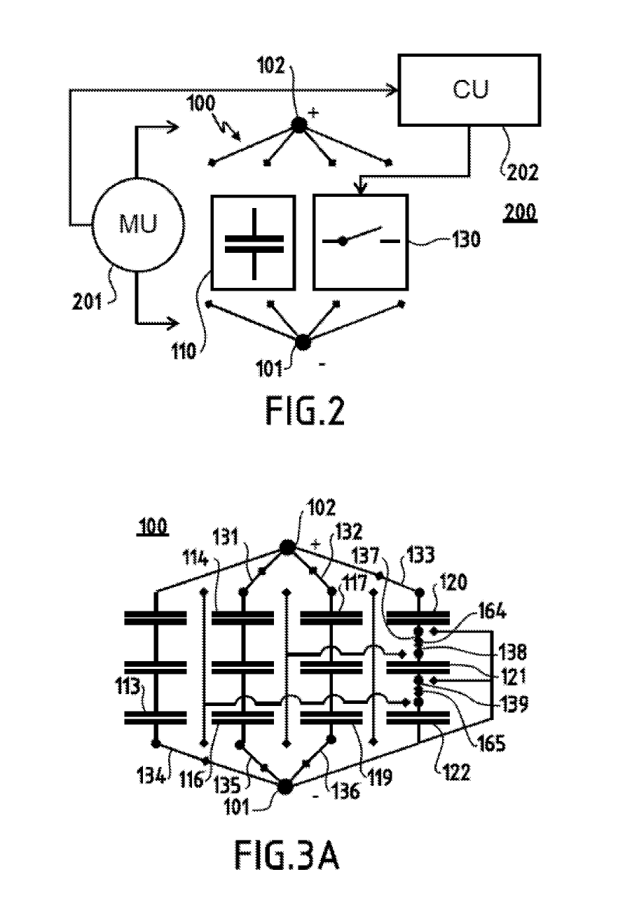

FIG. 2 shows an example reconfigurable energy storage device comprising such means. In particular, the device 200 comprises, in addition to the elements of the device 100, a measurement unit 201 arranged in order to measure a control voltage between two terminals and a control unit 202, arranged in order to drive the controlled inverters 130. The measurement unit 201 measures for example the voltage between the connection terminals 101 and 102 of the device 100. However, the control voltage may be measured between other points of the device 200, in particular between the terminals of one of the storage modules 110, inasmuch as this voltage is representative of the voltage at the terminals of the device 200. Such is the case in particular when all the storage modules are identical, charged and recharged identically at each moment, and when the combination of the storage modules is known. The control unit can have purely a hardware architecture, or a software architecture capable of executing a software program. It may be for example a programmable logic controller, a field-programmable gate array (FPGA), a processor, a microprocessor or a micro-controller. The reconfigurable energy storage device 200 may of course contain a safety switch, manual or controlled, similarly to FIG. 1B.

It should be noted that any change of combination involves adding or removing at least one storage module connected in series in the different branches of the reconfigurable device. At each reconfiguration, the voltage at the terminals of the device is thus increased or reduced by at least one times the voltage present at the terminals of one of the storage modules at the moment of the reconfiguration change. So as to ensure that the reconfigurable device has, both before and after reconfiguration, a voltage comprised within the desired functional range [Uₘₐₓ; Uₘᵢₙ], arrangements must be made so that the amplitude ΔUₘₐₓ of the voltage range [Uₘₐₓ; Uₘᵢₙ] is at least equal to the maximum voltage U_{mod-max} at the terminals of one and the same storage module. Similarly, there is a maximum number of storage modules that can be added or removed from a branch during a reconfiguration. This maximum number corresponds to the number of times that the maximum voltage U_{mod-max} at the terminals of one and the same storage module can be contained within the amplitude ΔUₘₐₓ of the desired functional range [Uₘₐₓ; Uₘᵢₙ]. Thus, for a given combination, the number n of storage modules capable of being added or removed must satisfy the following relationship:

n U_{mod-max}≤ΔUₘₐₓ≤ΔUₘₐₓ<(n+1) U_{mod-max}

FIGS. 3A to 3E show different possible combinations of the storage modules 110 in the device 100. In FIG. 3A, the controlled inverters 130 are arranged in order to form four branches in parallel (M=4) of three storage modules 110 connected in series (N=3). The controlled inverters 131, 132, 133 thus connect the positive terminal of the storage modules 114, 117 and 120, respectively, to the positive connection terminal 102 of the device 100. The controlled inverters 134, 135, 136 connect the negative terminal of the storage modules 113, 116 and 119, respectively, to the negative connection terminal 101 of the device 100.

The controlled inverters 137 and 138 respectively connect the negative terminal of the storage module 120 and the positive terminal of the storage module 121 to the connection point 164. The controlled inverters 139 and 140 respectively connect the negative terminal of the storage module 121 and the positive terminal of the storage module 122 to the connection point 165. In FIG. 3B, all the controlled inverters 130 have modified their connection with respect to FIG. 3A, apart from the controlled inverters 131 and 132. Consequently, the device 100 forms three branches in parallel (M=3) of four storage modules 110 in series (N=4). The first branch comprises the storage modules 111, 112, 113 and 122, the second branch comprises the storage modules 114, 115, 116 and 121, and the third branch comprises the storage modules 117, 118, 119 and 120. In FIG. 3C, the controlled inverters 131, 135, 137, 138, 139 and 140 have modified their connection with respect to FIG. 3B. The device 100 forms two branches in parallel (M=2) of six storage modules 110 in series (N=6). The first branch comprises the storage modules 111-116, and the second branch comprises the storage modules 117-122. In FIG. 3D, only the controlled inverters 132 and 135 have modified their connection with respect to the combination in FIG. 3C. The device 100 thus forms a single branch (M=1) of twelve storage modules in series (N=12). In each of the combinations in FIGS. 3A to 3D, all the storage modules 110 are incorporated into one of the branches. They are thus all charged or discharged simultaneously. To the extent that they are incorporated into branches each comprising one and the same number of storage modules, the storage modules 110 are identically loaded at each moment. FIG. 3E shows a combination in which not all the storage modules are used, namely the storage modules 120-122. The device 100 forms a single branch (M=1) of nine storage modules (N=9). In this combination, the controlled inverters 131, 132, 133 connect the positive terminal of the storage modules 114, 117 and 120, respectively, to the connection points 161, 162 and 163, respectively. The controlled inverters 134 and 135 connect the negative terminal of the storage modules 113 and 116, respectively, to the connection points 161 and 162, respectively. The controlled inverter 136 connects the negative terminal of the storage module 119 to the negative connection point 101 of the device 100. The position of the controlled inverters 137, 138, 139 and 140 is not important, as the storage modules 120-122 are not connected to the rest of the device 100.

It should be noted that when one or more storage modules 110 are not used in a given combination, this or these storage modules can be used in a subsequent combination, subject to each branch of the combination comprising one and the same number of storage modules that are not used. More generally, when the device 100 comprises several branches in parallel in a combination (M≥2), it is important that each branch has one and the same voltage at its terminals. In practice, this implies that each branch comprises an assembly of storage modules that collectively are charged identically.

### Combination With an Energy Converter

The reconfigurable energy storage device according to the invention can typically be incorporated into a power supply system also comprising an energy converter. The energy converter can be a direct current converter. This can also be a power inverter, when the reconfigurable energy storage device supplies electrical energy under a load, or a rectifier when the reconfigurable device receives electrical energy from an external source.

FIG. 4 shows an example of a power supply system 400 comprising the reconfigurable energy storage device 200 in FIG. 2 (the measurement unit is not shown) and an energy converter 410. The energy converter 410 operates alternately as power inverter and as rectifier, according to whether the reconfigurable device 200 is supplying energy or receiving it, respectively. It includes two connection terminals 411 and 412, on the alternating current side, and two connection terminals 413 and 414 on the direct current side. The connection terminals 411 and 412 are intended to be connected to a load that must be supplied by the reconfigurable device 200; and the connection terminals 413 and 414 are connected to the negative connection terminal 101 and to the positive connection terminal 102, respectively, of the device 200.

As the efficiency of an energy converter depends on the voltage it receives at the input, on two of its terminals, and the voltage that it must deliver at the output, on its other two terminals, it is preferable to make it operate over predetermined voltage ranges. In the present description, it is considered that the average voltage between the connection terminals 411 and 412 is constant. Only the voltage between the connection terminals 413 and 414 is considered. The voltage range over which the efficiency is optimum varies between a minimum voltage Uₘᵢₙ and a maximum voltage Uₘₐₓ, and is called optimum operating range [Uₘₐₓ; Uₘᵢₙ]. This range is for example determined so that the energy converter has an efficiency q greater than 90%, or greater than 95%. Typically, an energy converter has an efficiency η greater than 95% over an operating range the lower boundary of which Uₘᵢₙ is approximately equal to two-thirds of the maximum voltage Uₘₐₓ, i.e. an amplitude equal to one third of the maximum voltage Uₘₐₓ.

Switch-over of the controlled inverters or, more generally, of the controlled contactors, should preferentially be carried out under low current flow conditions so as to avoid deterioration of these controlled contactors. A switch-over of the controlled contactors is therefore advantageously carried out with a low current, or even none. As a result, during a relatively short period of time (of the order of a few tenths of a second), corresponding to the period necessary for changing the combination of the storage modules 110, only a limited quantity of energy, or no energy, can be transferred between the device 200 and the energy converter 410. The energy converter 410 is thus advantageously informed of the change in the combination of the storage modules 110, so as to limit the energy conversion demand. This temporary limitation on the supply of electrical energy can introduce a difficulty in applications of the “uninterruptible power supply” type, which by definition need a constant energy supply. An uninterruptible power supply system is used for example as a back-up power source, making it possible to ensure continuity of the energy supply service when the mains electricity grid is down. A solution is to couple the reconfigurable energy storage device 200 with another electrical power source, such as a charge transfer electrochemical energy storage device. For other applications, temporary limitation of the electrical energy supply does not present any difficulty. By way of example, the reconfigurable device 200 and the supply system 400 are particularly well adapted to applications of the “electric or hybrid vehicles” and “network filtering” types. The expression “electric or hybrid vehicle” denotes the group of vehicles intended for transporting people and/or goods, and based on at least partial, and/or intermittent use of an electric motor for moving the vehicle. The vehicle is for example an underground train, a tram, a bus, a boat, a car, a two-wheeler, a lorry, a travelling platform, a lift or a crane. The electric or hybrid vehicle benefits from a mechanical inertia that can overcome the energy supply limitation. The term “network filtering” denotes the set of electrical devices making it possible to improve the quality of the energy supplied by an electricity grid. Currently, some devices are based mainly on capacitors arranged in order to optimize the power factor (“cos phi”) of an alternating current electrical grid. Other devices comprise charge transfer electrochemical energy storage devices, making it possible to smooth an intermittent energy flow, for example produced by wind turbines or photovoltaic panels. Electrochemical energy storage devices accumulate energy during a sudden power increase, as a result for example of a gust of wind or when the sun returns from behind a cloud, and release additional energy during sudden power decreases, for example as a result of the wind dropping, or a cloud passing over the sun. The capacitors and the electrochemical energy storage devices of these devices can thus be replaced by the reconfigurable energy storage device according to the invention.

Other precautions must be taken during the switch-over of the controlled contactors. In particular, it is preferable to avoid momentarily placing in parallel, branches containing different numbers of storage modules in series. Otherwise, some storage modules will discharge into other storage modules, which will lead to imbalance in their state of charge. It is thus preferable to manoeuvre the controlled contactors in a certain order, or even to manoeuvre controlled contactors that a priori, in view of the initial combination and the final combination, need not have been moved, in order to momentarily isolate branches from one another.

A further precaution to be taken during switch-over of the controlled contactors relates to the voltage present at each moment at the terminals of the reconfigurable energy storage device. This voltage must typically be comprised within a predetermined voltage range, for example the optimum operating range [Uₘₐₓ; Uₘᵢₙ] of the energy converter. To this end, the control unit can be arranged so that, during any change of combination, any branch connected to the negative 101 and positive 102 connection terminals of the device 100 has the same number of storage modules in series as either that of a branch of the combination before reconfiguration, or that of a branch of the combination after reconfiguration.

FIGS. 5A and 5B show an example of sequencing of the switch-over of the controlled inverters 130 while switch-over from the combination (FIG. 5A) comprising four branches in parallel of three storage modules 110 connected in series (M×N=4×3) to the combination (FIG. 5B) comprising three branches in parallel of four storage modules 110 in series (M×N=3×4). In a first step, marked \textcircled{1}, the controlled inverters 133, 134 and 135 are activated, which has the effect of disconnecting the storage modules, respectively 120, 113 and 116, from the negative 101 and positive 102 connection terminals. In a second step, marked \textcircled{2}, the controlled inverters 137 and 139 are activated. In a third step, marked \textcircled{3}, the controlled inverter 136 is activated. In a fourth step, marked \textcircled{4}, the controlled inverters 138 and 140 are activated. In each step, the controlled inverters can be activated successively or simultaneously.

With the aim of ensuring that the switch-over of the controlled contactors is carried out in the desired order, provision may be made for a mechanism for verifying the position of the different controlled contactors. This verification mechanism for example sends data feedback to the control unit, allowing it to activate the successive switch-overs of the controlled contactors.

### Generalization

It is noted that the reconfigurable energy storage device according to the invention can include any number M×N of storage modules, with M and N two natural numbers greater than or equal to one.

Different optimizations of the combinations are possible, in particular in terms of available energy, efficiency of the energy converter and/or number of configurations.

### Optimization in Terms of Available Energy

The optimization in terms of available energy assumes that at any time, the assembly M×N of storage modules is used. In other words, regardless of the combination i, the following relationship is complied with:

Mᵢ×Nᵢ=M×N

The following combinations, defined by a pair Mᵢ×Nᵢ, are possible in particular:

| Initial | | M₂ × | | M₄ × | | M₆ × |
|---|---|---|---|---|---|---|
| M | M₁ × N₁ | N₂ | M₃ × N₃ | N₄ | M₅ × N₅ | N₆ |
| 3 | 3 × 2k | 2 × 3k | 1 × 6k | | | |
| 4 | 4 × 3k | 3 × 4k | 2 × 6k | 1 × 12k | | |
| 5 | 5 × 4k | 4 × 5k | 2 × 10k | 1 × 20k | | |
| 5 | 5 × 12k | 4 × 15k | 3 × 20k | 2 × 30k | 1 × 60k | |
| 6 | 6 × 2k | 4 × 3k | 3 × 4k | 2 × 6k | 1 × 12k | |
| 6 | 6 × 10k | 5 × 12k | 4 × 15k | 3 × 20k | 2 × 30k | 1 × 60k |
| 7 | 7 × 6k | 6 × 7k | 3 × 14k | 2 × 21k | 1 × 42k | |
| 8 | 8 × 3k | 6 × 4k | 4 × 6k | 3 × 8k | 2 × 12k | 1 × 24k |
| 9 | 9 × 4k | 6 × 6k | 4 × 9k | 3 × 12k | 2 × 18k | 1 × 36k |

In these combinations, k is a strictly positive natural integer and makes it possible to indicate that the integer Nᵢ is a multiple of the specified integer. Furthermore, M can be a multiple of the integer in question, providing that it is not desired to use the combinations in their entirety. For example, the series of combinations starting with 6×2k is merely a continuation of the first terms of the series starting with 3×2k, grouping the branches two by two. The same goes for the series starting with 8×3k and 4×3k.

### Optimization in Terms of Efficiency of the Energy Converter

When the reconfigurable device according to the invention is combined with an energy converter, it is beneficial to use combinations such that the voltage at the connection terminals of the device can be situated at each moment within the optimum operating range [Uₘₐₓ; Uₘᵢₙ] of this energy converter. This condition is expressed by the following relationship:

$$\frac{{N}_{i}}{{N}_{i + 1}} > {k}_{η}$$

where k_{η} is defined by:

$${k}_{η} = \frac{{U}_{m i n}}{{U}_{m a x}}$$

The series of combinations starting with 9×4k for example offers good optimization inasmuch as between each consecutive combination, the ratio of Nᵢ to Nᵢ₊₁ is always greater than two-thirds.

The following table presents different possible combinations making it possible to optimize the efficiency of the energy converter in the case where=⅔. U_{device-max} and U_{device-min} respectively denote the maximum and minimum voltages at the terminals of the reconfigurable device.

| | Com- | | | | | | | Usa- |
|---|---|---|---|---|---|---|---|---|
| | bi- | | | | | | | ble |
| | na- | | | | | | | en- |
| | tions | M | N | U_{device-max} | U_{mod-max} | U_{device-min} | U_{mod-min} | ergy |
| A | 1 | 4 | 3k | 3k Uₙ | Uₙ | $\frac{2}{3} 3 k {U}_{n}$ | $\frac{2}{3} {U}_{n}$ | 55% |
| | 2 | 3 | 4k | $\frac{8}{9} 3 k {U}_{n}$ | $\frac{2}{3} {U}_{n}$ | $\frac{2}{3} 3 k {U}_{n}$ | $\frac{1}{2} {U}_{n}$ | 75% |
| | 3 | 2 | 6k | 3k Uₙ | $\frac{1}{2} {U}_{n}$ | $\frac{2}{3} 3 k {U}_{n}$ | $\frac{1}{3} {U}_{n}$ | 89% |
| B | 1 | 6 | 2k | 2k Uₙ | Uₙ | $\frac{2}{3} 2 k {U}_{n}$ | $\frac{2}{3} {U}_{n}$ | 55% |
| | 2 | 4 | 3k | 2k Uₙ | $\frac{2}{3} {U}_{n}$ | $\frac{2}{3} 2 k {U}_{n}$ | $\frac{4}{9} {U}_{n}$ | 80% |
| | 3 | 3 | 4k | $\frac{8}{9} 2 k {U}_{n}$ | $\frac{4}{9} {U}_{n}$ | $\frac{2}{3} 2 k {U}_{n}$ | $\frac{1}{3} {U}_{n}$ | 89% |
| C | 1 | 9 | 4k | 4k Uₙ | Uₙ | $\frac{2}{3} 4 k {U}_{n}$ | $\frac{2}{3} {U}_{n}$ | 55% |
| | 2 | 6 | 6k | 4k Uₙ | $\frac{2}{3} {U}_{n}$ | $\frac{2}{3} 4 k {U}_{n}$ | $\frac{4}{9} {U}_{n}$ | 80% |
| | 3 | 4 | 9k | 4k Uₙ | $\frac{4}{9} {U}_{n}$ | $\frac{2}{3} 4 k {U}_{n}$ | $\frac{8}{27} {U}_{n}$ | 91% |

The following table presents different possible combinations making it possible to optimize the efficiency of the energy converter in the case where k_{η}=¾.

| Com- | | | | | | | Usa- |
|---|---|---|---|---|---|---|---|
| bi- | | | | | | | ble |
| na- | | | | | | | en- |
| tions | M | N | U_{device-max} | U_{mod-max} | U_{device-min} | U_{mod-min} | ergy |
| 1 | 6 | 10k | 10k Uₙ | Uₙ | $\frac{3}{4} 10 k {U}_{n}$ | $\frac{3}{4} {U}_{n}$ | 44% |
| 2 | 5 | 12k | $\frac{9}{10} 10 k {U}_{n}$ | $\frac{3}{4} {U}_{n}$ | $\frac{3}{4} 10 k {U}_{n}$ | $\frac{5}{8} {U}_{n}$ | 61% |
| 3 | 4 | 15k | $\frac{15}{16} 10 k {U}_{n}$ | $\frac{5}{8} {U}_{n}$ | $\frac{3}{4} 10 k {U}_{n}$ | $\frac{1}{2} {U}_{n}$ | 75% |
| 4 | 3 | 20k | 10k Uₙ | $\frac{1}{2} {U}_{n}$ | $\frac{3}{4} 10 k {U}_{n}$ | $\frac{3}{8} {U}_{n}$ | 86% |

It should be noted that this series of combinations is the only one to respect the condition:

$$\frac{{N}_{i}}{{N}_{i + 1}} > \frac{3}{4}$$

Any other initial combination requires leaving unused storage modules in one of the following combinations, unless the integer k makes it possible to pass through an intermediate combination respecting the above condition. For example, in the case of a reconfigurable device with the initial combination M×N=8×15, the following series of combinations is possible.

| Com- | | | | | | | Usa- |
|---|---|---|---|---|---|---|---|
| bi- | | | | | | | ble |
| na- | | | | | | | en- |
| tions | M | N | U_{device-max} | U_{mod-max} | U_{device-min} | U_{mod-min} | ergy |
| 1 | 8 | 15 | 15 Uₙ | Uₙ | $\frac{3}{4} 15 {U}_{n}$ | $\frac{3}{4} {U}_{n}$ | 44% |
| 2 | 6 | 20 | 15 Uₙ | $\frac{3}{4} {U}_{n}$ | $\frac{3}{4} 15 {U}_{n}$ | $\frac{9}{16} {U}_{n}$ | 68% |
| 3 | 5 | 24 | $\frac{9}{10} 15 {U}_{n}$ | $\frac{9}{16} {U}_{n}$ | $\frac{3}{4} 15 {U}_{n}$ | $\frac{15}{32} {U}_{n}$ | 78% |
| 4 | 4 | 30 | $\frac{15}{16} {U}_{n}$ | $\frac{15}{32} {U}_{n}$ | $\frac{3}{4} 15 {U}_{n}$ | $\frac{3}{8} {U}_{n}$ | 86% |
| 5 | 3 | 40 | 15 Uₙ | $\frac{3}{8} {U}_{n}$ | $\frac{3}{4} 15 {U}_{n}$ | $\frac{9}{32} {U}_{n}$ | 92% |

The following example, still in the case where k_{η}=¾, shows how it is possible to manage a series of reconfigurations while leaving out storage modules in certain combinations, in order to reincorporate them in a following combination.

| Com- | | | | | | | Usa- |
|---|---|---|---|---|---|---|---|
| bi- | | | | | | | ble |
| na- | | | | | | | en- |
| tions | M | N | U_{device-max} | U_{mod-max} | U_{device-min} | U_{mod-min} | ergy |
| 1 | 4 | 8 | 8 Uₙ | Uₙ | $\frac{3}{4} 8 {U}_{n}$ | $\frac{3}{4} {U}_{n}$ | 44% |
| 2 | 3 | 10 | $\frac{15}{16} 8 {U}_{n}$ | $\frac{3}{4} {U}_{n}$ | $\frac{3}{4} 8 {U}_{n}$ | $\frac{3}{5} {U}_{n}$ | 60% |
| | — | 2 | $Isolated modules . Voltage stabilized at \frac{3}{4} {U}_{n}$ | | | | |
| 3 | 2 | 12 + 1 | $\frac{159}{160} 8 {U}_{n}$ | $\begin{matrix}\frac{3}{5} {U}_{n} \\ \frac{3}{4} {U}_{n}\end{matrix}$ | $\frac{3}{4} 8 {U}_{n}$ | $\begin{matrix}\frac{9}{20} {U}_{n} \\ \frac{3}{5} {U}_{n}\end{matrix}$ | 64% |
| | — | 6 | $Isolated modules . Voltage stabilized at \frac{3}{5} {U}_{n}$ | | | | |
| 4 | 2 | 12 + 4 | $\frac{39}{40} 8 {U}_{n}$ | $\begin{matrix}\frac{9}{20} {U}_{n} \\ \frac{3}{5} {U}_{n}\end{matrix}$ | $\frac{3}{4} 8 {U}_{n}$ | $\begin{matrix}\frac{27}{80} {U}_{n} \\ \frac{39}{80} {U}_{n}\end{matrix}$ | 86% |

In this latter example, combination 2 leaves out two storage modules. As no current passes through these modules, they remain in the same state of charge throughout the period of the combination. Combination 3 reintroduces the two modules isolated in combination 2, at the rate of one per branch, and isolates six others therefrom. Combination 4 reintroduces the six isolated modules, at the rate of three storage modules per branch.

### Optimization in Terms of Number of Reconfigurations

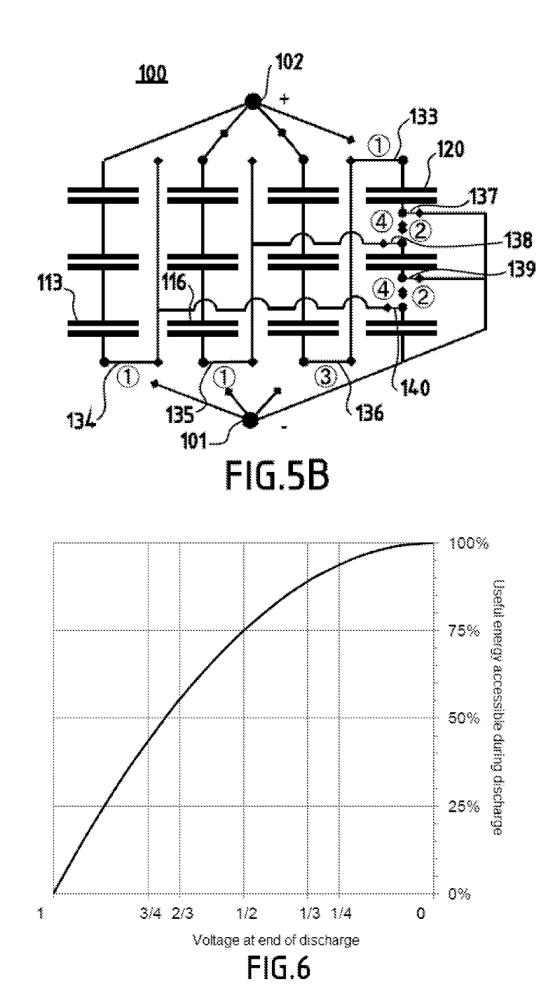

FIG. 6 shows a characteristic of a energy storage module by capacitive effect. It represents the useful energy accessible during a discharge of the storage module as a function of the voltage at its terminals at the end of discharge. The x-axis corresponds to the voltage at the end of discharge, as a percentage with respect to the maximum voltage U_{mod-max}, and the y-axis corresponds to the accessible useful energy, as a percentage with respect to the total energy available in the storage module. This figure shows that 90% of the nominal energy of the storage module is accessible over a voltage range [U_{mod-max}; U_{mod-min}], where U_{mod-min} is approximately equal to one third of U_{mod-max}. Thus, the use of 90% of the energy of the reconfigurable energy storage device according to the invention requires a maximum number of storage modules per branch strictly less than three times the minimum number of storage modules per branch. The strict inferiority relationship is due to the voltage variation at the terminals of the storage modules. The combinations can thus be the following:

| Initial M | M₁ × N₁ | M₂ × N₂ | M₃ × N₃ | M₄ × N₄ |
|---|---|---|---|---|
| 3 | 3 × 2k | 2 × 3k | | |
| 4 | 4 × 3k | 3 × 4k | 2 × 6k | |
| 5 | 5 × 4k | 4 × 5k | 2 × 10k | |
| 5 | 5 × 12k | 4 × 15k | 3 × 20k | 2 × 30k |
| 6 | 6 × 2k | 4 × 3k | 3 × 4k | |
| 6 | 6 × 10k | 5 × 12k | 4 × 15k | 3 × 20k |
| 7 | 7 × 6k | 6 × 7k | 3 × 14k | |
| 8 | 8 × 3k | 6 × 4k | 4 × 6k | 3 × 8k |
| 9 | 9 × 4k | 6 × 6k | 4 × 9k | |

As previously indicated, the control unit can drive the controlled contactors so that the voltage U_{device} at the terminals of the reconfigurable device according to the invention is situated within the voltage range [Uₘₐₓ; Uₘᵢₙ], corresponding for example to the optimum operating range of the energy converter. The control unit can thus be arranged so that, when the voltage U_{device} becomes less than the minimum voltage Uₘᵢₙ, or greater than the voltage Uₘₐₓ, the controlled contactors are driven in order to connect the storage modules in a new combination, in which the voltage U_{device} returns within the voltage range [Uₘₐₓ; Uₘᵢₙ].

As the energy converter can introduce voltage oscillations, of the order of a few volts, a phenomenon of erratic oscillation between two combinations can be noted if the change of combination is carried out at one and the same voltage, both on charging and on discharging of the reconfigurable device. In order to avoid such a phenomenon, it is possible to introduce hysteresis of several volts (for example 1 to 5 volts) around each voltage of the change in combination. By way of illustration, a first combination of M₁ branches in parallel is considered, each having N₁ storage modules, and a second combination of M₂ branches in parallel each having N₂ storage modules, with N₂>N₁ and M₁×N₁=M₂×N₂. Under discharge, the switch-over from the first combination to the second can be carried out when the voltage U_{device} reaches a voltage U_{dech} that is a few volts less than the voltage Uₘᵢₙ. On the other hand, under charge, the switch-over from the second combination to the first can be carried out when the voltage U_{device} reaches the voltage Uₘᵢₙ.

Another solution for introducing a hysteresis is to work with a ratio N₁/N₂ that is slightly above the quotient k_{η} of the minimum voltage Uₘᵢₙ over the maximum voltage Uₘₐₓ, while retaining the reconfiguration thresholds at the terminals of the optimum operating range [Uₘₐₓ; Uₘᵢₙ]. Under discharge, the voltage U_{device} changes from Uₘᵢₙ=k_{η} Uₘₐₓ to N₁/N₂.Uₘᵢₙ, which is very slightly less than Uₘₐₓ. Under charge, the voltage U_{device} changes from the voltage Uₘₐₓ to N₁/N₂.Uₘₐₓ, which is very slightly less than k_{η} Uₘₐₓ. With respect to the previous one, this second solution has the advantage of retaining a voltage U_{device} in the optimum operating range of the energy converter.

The reconfigurable energy storage device according to the invention is particularly suitable for supplying electric public transport vehicles, in particular when they carry out journeys including predetermined halts at bus stops. Such is the case in particular for buses and trams. The reconfigurable energy storage device of the vehicle can in fact be recharged regularly during the halts at stops, making it possible for it to accumulate sufficient energy in order to travel autonomously between the stops. The stops are then described as “charging stations”. The technology of energy storage by capacitive effect, covering in particular supercapacitors, allows relatively short durations for recharging, compatible with the period that the vehicle is halted at a stop, typically of the order of around ten seconds, or even a maximum of around thirty seconds.

According to a first example of use of the reconfigurable energy storage device according to the invention, this device supplies a vehicle including a drive train (infinitely variable speed transmission+motor) operating over an input voltage range comprised between 300 V and 450 V, with an optimum energy efficiency comprised between 330 V and 430 V. In order to better understand the advantages of the use of a reconfigurable device according to the invention, firstly, by way of comparison, a non-reconfigurable energy storage device by capacitive effect is considered, i.e. one in which the combination of storage modules is fixed. This non-reconfigurable device comprises for example four branches in parallel of eight storage modules connected in series, each storage module having a maximum voltage between its terminals U_{mod-max} of 50 V. Thus, the maximum voltage at the terminals of the device is 400 V, which is close to the upper boundary of the optimum operating range of the drive train (430 V). On the other hand, discharging the non-reconfigurable device until its voltage reaches the lower boundary of the optimum operating range (330 V) only allows a small part of the energy stored in the device to be used, i.e. approximately 33%. This part can reach approximately 50% if discharge is allowed to a voltage of 300 V, but remains relatively small. For a given autonomy of the electric vehicle, this rate of use of the stored energy requires over-dimensioning of the non-reconfigurable storage device.

The reconfigurable energy storage device according to the invention makes it possible to increase the autonomy available based on one and the same number of storage modules, to optimize the number of branches in parallel, or to reach a compromise between these two options. In the case of an increase in autonomy, it can be observed that, according to the table presented below with one initial combination of four branches in parallel, each having eight storage modules, up to 86% of the stored energy can be used. In the case where optimization of the number of branches is sought, it is noted that the reconfigurable device can comprise only two branches in parallel, each having eight storage modules (M×N=2×8). The following combinations can be used.

| Combinations | M | N | U_{device-max} | U_{mod-max} | U_{device-min} | U_{mod-min} | Usable energy |
|---|---|---|---|---|---|---|---|
| 1 | 2 | 8 | 400 | 50 | 330 | 41.25 | 32% |
| 2 | 1 | 10 | 412.5 | 41.25 | 330 | 33 | 35% |
| | — | 6 | Isolated modules. Voltage stabilized at 41.25 V | | | | |
| 3 | 1 | 6 | 412.5 | 41.25 | 330 | 33.75 | 44% |
| | | +5 | | 33 | | 25.5 | |
| | — | 5 | Isolated modules. Voltage stabilized at 33 V | | | | |
| 4 | 1 | 6 | 418.5 | 33.75 | 330 | 27 | 60% |
| | | +5 | | 33 | | 26.2 | |
| | | +2 | | 25.5 | | 18.5 | |
| | — | 3 | Isolated modules. Voltage stabilized at 25.5 V | | | | |
| 5 | 1 | 6 | 406.5 | 27 | 330 | 22.2 | 83% |
| | | +5 | | 26.2 | | 21.4 | |
| | | +2 | | 18.5 | | 13.7 | |
| | | +3 | | 25.5 | | 20.8 | |

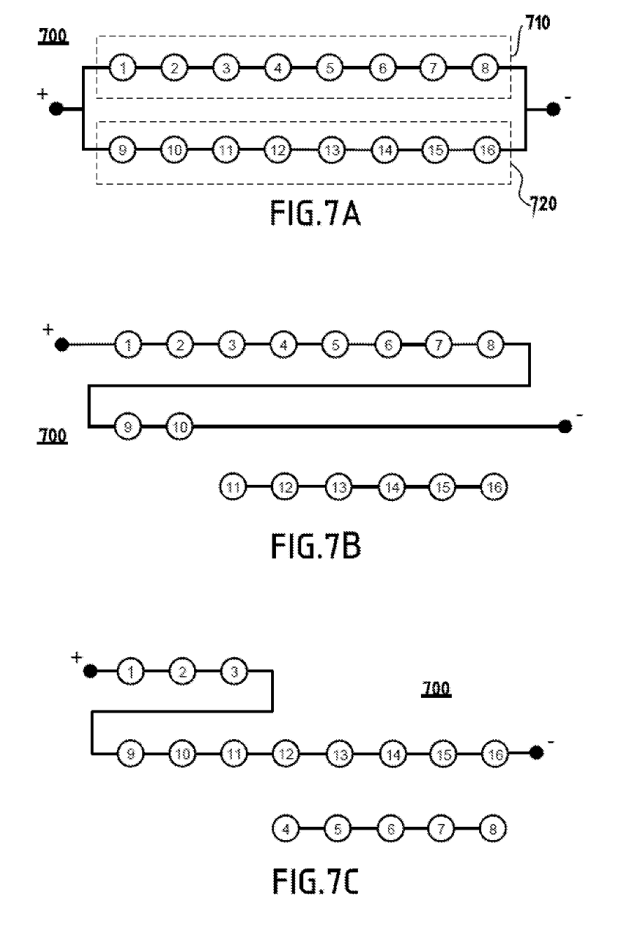

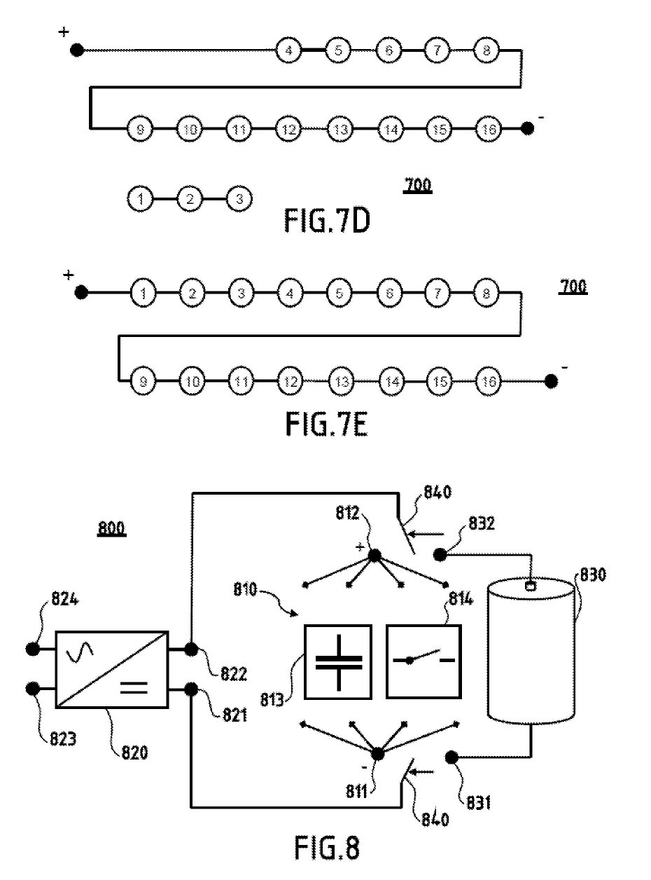

FIGS. 7A-7E diagrammatically show the different corresponding combinations. In FIG. 7A, showing the first combination, the device 700 comprises two branches in parallel, each of eight storage modules in series.

The first branch 710 comprises storage modules numbered consecutively from 1 to 8 and the second branch 720 comprises storage modules numbered consecutively from 9 to 16. In FIG. 7B, showing the second combination, the device 700 comprises a single branch formed from the storage modules 1 to 10, the storage modules 11 to 16 being isolated. In FIG. 7C, showing the third combination, the device 700 still comprises a single branch, but this time formed from the storage modules 1 to 3 and 9 to 16, the storage modules 4 to 8 being isolated. In FIG. 7D, showing the fourth combination, the device 700 comprises a single branch formed from the storage modules 4 to 16, the storage modules 1 to 3 being isolated. In the last combination, shown in FIG. 7E, the device comprises a single branch formed from the assembly of sixteen storage modules connected in series. In order to allow these different combinations, the device 700 comprises a controlled contactor between the storage modules 3 and 4, between the storage modules 10 and 11, between the storage module 8 and the negative connection terminal of the device 700 and between the storage module 9 and the positive connection terminal of the device 700.

According to a second example of use of the reconfigurable device according to the invention, this device supplies an electric vehicle the drive train of which operates over an input voltage range comprised between 300 V and 750 V, with an optimum energy efficiency comprised between 350 V and 730 V. As the operating range is relatively broad (with Uₘₐₓ>2 Uₘᵢₙ), it may be envisaged to use a non-reconfigurable energy storage device by capacitive effect. However, the reconfigurable device according to the invention is particularly beneficial for recharging the electric vehicle at a stop. In fact, on arrival at a stop, the reconfigurable device can have a voltage at its terminals of 350 V and require recharging via an energy converter delivering a voltage of 700 V at its terminals. The energy converters are mainly of two types, namely step-up and step-down. With a step-up converter, the input voltage range is less than the output voltage range. Now, as the recharging period needs to be short, high currents must pass between the station and the electric vehicle, which requires specific connectors and involves significant design and maintenance costs. Moreover, losses through Joule effect are significant. With a step-down converter, the input voltage range is greater than the output voltage range. A drawback of this energy converter is the safety risk. The recharging station is typically situated in an urban environment, with a risk of electrical contact with passengers or passers-by. The presence of this high voltage and the significant power transferred thus requires very strict safety measures in terms of mechanical integration, materials and thus costs.

The reconfigurable energy storage device according to the invention limits these drawbacks by allowing recharging in two stages. The reconfigurable device includes for example two branches (or a multiple of two branches) of fourteen modules in series, each storage module having a maximum voltage at its terminals of 50 V. In the case of a step-up energy conversion device, operating for example over a voltage range comprised between 225 V and 450 V and an output voltage range comprised between 500 V et 1000 V, in a first stage, the two branches are placed in series (or the branches are placed in series two by two) in order to form a branch of 28 modules. The voltage at the terminals of this branch will change from 700 V to 1000 V. In a second stage, the reconfigurable device returns to its initial configuration (M×N=2k×14) in order to complete the recharging of the storage modules, the voltage at their terminal changing from 500 V a 700 V. In the case of a step-down energy conversion device, operating over an input voltage range comprised between 500 V a 1000 V and an output voltage range comprised between 225 V et 450 V, in a first stage, the reconfigurable device is left in its initial configuration (M×N=2k×14), the voltage at the terminals of each branch changing from 350 V to 450 V. In a second stage, each branch of fourteen storage modules is divided into two parallel branches of seven storage modules each. On recharging, the voltage at the terminals of the branches changes from 225 V to 350 V. The device is then reconfigured into its initial configuration, each branch having a voltage at its terminals of 700 V. In terms of personal safety, the use of a step-down energy converter is preferable to the use of a step-up converter, inasmuch as the highest voltages are located upstream of the energy converter, a priori installed within the recharging station and thus less accessible to people. The use of a step-up converter, on the other hand, places the highest voltages downstream of the energy converter, and in particular on the power connection device between the recharging station and the vehicle, generally more accessible to people.

The reconfigurable device according to the invention has advantages as a power supply source of an electric vehicle. It can also be useful in a recharging station, in order to facilitate the transfer of energy during recharging of the reconfigurable device on board the vehicle at a stop. The reconfigurable device arranged in the recharging station, called “ground reconfigurable device”, has a relatively long time for recharging, of the order of several minutes, corresponding to the time interval between two halts of vehicles in the recharging station. The power transfer values are therefore markedly lower, which allows recharging directly from the electricity grid. A power supply system for an electric or hybrid vehicle can thus include a first reconfigurable energy storage device according to the invention, on board the vehicle, in order to supply it autonomously between two stops, a second reconfigurable device according to the invention, placed in each recharging station, and an energy converter arranged in order to connect the two reconfigurable devices. The electrical properties of the drive train of the vehicle impose the voltage range of the on-board reconfigurable device and, consequently, the number of storage modules in series in each branch. The autonomy required between two recharging stations for its part sets the number of branches in parallel in the on-board reconfigurable device.

By way of example, an on-board reconfigurable device is considered comprising, in an initial combination, four branches in parallel, each of eight storage modules in series, i.e. a total of thirty-two storage modules. The energy to be transferred from the reconfigurable device on the ground to the on-board reconfigurable device corresponds to the useful energy for the vehicle to move between two recharging stations, disregarding the losses due to the energy transfer, in particular in the energy converter. The reconfigurable device on the ground thus comprises one and the same number of storage modules. The voltage range within which the reconfigurable device on the ground must operate is imposed by the conversion ratio of the energy converter. In the case of a step-down energy converter with a ratio of 1/2, the reconfigurable device on the ground works at a voltage that is double that of the on-board reconfigurable device. Its thirty-two storage modules are thus connected in a combination of two branches in parallel of sixteen storage modules (M×N=2×16). The on-board reconfigurable device and the reconfigurable device on the ground can be produced from one and the same basic reconfigurable device, comprising four branches of eight storage modules in series, and a connection system making it possible to choose either a parallel combination of the four branches, or a combination of two branches in parallel of sixteen storage modules. In the case of a step-up energy converter with a ratio of 2, the reconfigurable device on the ground works at a voltage that is half that of the on-board reconfigurable device. The thirty-two storage modules of this reconfigurable device are thus connected in a combination of eight branches in parallel of four storage modules in series. The on-board reconfigurable device and the reconfigurable device on the ground can also be produced from one and the same basic reconfigurable device, comprising eight branches of four storage modules in series, and a connection system making it possible to choose either a parallel combination of the eight branches, or a combination of four branches in parallel of eight storage modules. The connection system can include bus-bars, bolted at the end of production into the required position according to the destination of the reconfigurable device, namely the vehicle or the recharging station. The connection system can also include manually-controlled switches, such as manual power breakers, the position of which is determined as a function of the destination of the reconfigurable device. It must be noted that the destination of the reconfigurable device is a priori definitive. It is therefore not necessary for the connection system used to be capable of being controlled. However, controlled contactors such as those used during charging or discharging of the reconfigurable devices can be used.

The reconfigurable energy storage device according to the invention can be combined with other electrical power supply sources, in particular with a charge transfer electrochemical energy storage device (electric battery or fuel cell), or a generator unit. These additional power supply sources can back up the reconfigurable device in the case of short power cuts, for example during the changes of combination, as well as in the case of sudden power demand, or when the reconfigurable device is discharged.

FIG. 8 shows an example of a power supply system comprising an electrical power supply source in addition to the reconfigurable device according to the invention. The electrical power supply system 800 comprises a reconfigurable device 810, an energy converter 820, an electric battery 830 and a controlled switch 840. The reconfigurable device 810 comprises a negative connection terminal 811, a positive connection terminal 812, an assembly of storage modules 813, and an assembly of controlled inverters 814. The electric battery 830 comprises a negative connection terminal 831 and a positive connection terminal 832. The energy converter 820 comprises two input terminals 821, 822 and two output terminals 823, 824. Of course, the energy converter 820 can operate in both directions, despite the connection terminals being described as “input” or “output” for the purposes of description only. The controlled switch 840 is for example driven by the control unit of the reconfigurable device 810, or by any control means of the power supply system. It makes it possible to connect the input terminals 821, 822 of the energy converter either to the connection terminals 811, 812 of the reconfigurable device 810, or to the connection terminals 831, 832 of the electric battery.

Of course, the invention is not limited to the examples which have just been described and numerous adjustments can be made to these examples without exceeding the scope of the invention. In addition, the different characteristics, forms, variants and embodiments described can be combined together in various combinations inasmuch as they are not incompatible or mutually exclusive.

1. A reconfigurable electrical energy storage device comprising:
M×N storage modules, where M and N are strictly positive natural numbers, each storage module being capable of storing electrical energy by capacitive effect between a negative terminal and a positive terminal;
contactors arranged in order to make it possible to connect by their terminals Mᵢ×Nᵢ storage modules, in different combinations, each combination denoted by an index i comprising Mᵢ branches connected in parallel, each branch comprising Nᵢ storage modules connected in series, where Mᵢ×Nᵢ≤M×N; and
positive and negative electrical connection terminals to which are capable of being connected, in each combination, the ends of the branches connected in parallel.

2. The device according to claim 1, in which the contactors are controlled contactors.

3. The device according to claim 1, also comprising a safety contactor arranged in order to be able to adopt an isolation position, in which, for at least one combination of the storage modules, each branch is isolated from the positive electrical connection terminal and/or from the negative electrical connection terminal.

4. The device according to claim 3, in which the safety contactor is a controlled contactor.

5. The device according to claim 1, in which the M×N storage modules have one and the same maximum voltage U_{mod-max} at their terminals and one and the same capacitance.

6. The device according to claim 1, in which the contactors are arranged so that, for each combination, the product Mᵢ×Nᵢ of the number of branches times the number of storage modules in each branch is equal to the number M×N of storage modules in the reconfigurable electrical energy storage device.

7. The device according to one of the preceding claims claim 1, in which the contactors are arranged so that, among the different combinations, the maximum number Nₘₐₓ of storage modules in each branch is less than or equal to three times the minimum number Nₘᵢₙ of storage modules in each branch.

8. The device according to claim 2, also comprising:
a measurement unit, arranged in order to measure a control voltage between the negative terminal of a first storage module among the M×N storage modules, and the positive terminal of a second storage module among the M×N storage modules, identical to or different from the first storage module; and
a control unit, arranged in order to drive the controlled contactors as a function of the control voltage.

9. The device according to claim 8, in which the control unit is arranged so that, when the control voltage becomes less than a minimum voltage Uₘᵢₙ, or greater than a maximum voltage Uₘₐₓ, the controlled contactors are driven in order to connect the storage modules in a new combination, in which the control voltage is comprised between the minimum voltage Uₘᵢₙ, and the maximum voltage Uₘₐₓ.

10. The device according to claim 8, in which the control unit is arranged so that:
when the control voltage becomes less than a minimum discharge voltage U_{dech}, the controlled contactors are driven in order to connect the storage modules in a new combination, in which the control voltage is comprised between a minimum operating voltage Uₘᵢₙ, and a maximum operating voltage Uₘₐₓ, where U_{dech}<Uₘᵢₙ<Uₘₐₓ; and/or
when the control voltage becomes greater than a maximum load voltage U_{ch}, the controlled contactors are driven in order to connect the storage modules in a new combination, in which the control voltage is comprised between a minimum operating voltage Uₘᵢₙ, and a maximum operating voltage Uₘₐₓ, where Uₘᵢₙ<Uₘₐₓ<U_{ch}.

11. The device according to claim 8, in which the measurement unit is arranged in order to measure the control voltage between the positive and negative electrical connection terminals of the configurable device.

12. The device according to claim 5, in which the control unit and the storage modules are arranged such that the voltage difference ΔUₘₐₓ between the maximum operating voltage Uₘₐₓ and the minimum operating voltage Uₘᵢₙ is greater than or equal to the maximum voltage U_{mod-max} at the terminals of a storage module.

13. The device according to claim 5, in which the control unit and the storage modules are arranged so that the number of storage modules capable of being added or removed in each branch during switch-over from one combination to a next combination is less than or equal to a maximum number nₘₐₓ, determined so as to satisfy the relationship:
nₘₐₓU_{mod-max}≤ΔUₘₐₓ≤(nₘₐₓ+1)U_{mod-max}
where ΔUₘₐₓ is the voltage difference between the maximum operating voltage Uₘₐₓ and the minimum operating voltage Uₘᵢₙ between the positive and negative electrical connection terminals of the reconfigurable device.

14. A power supply system capable of supplying power for a load and being recharged by a recharging station, the system comprising:
a reconfigurable electrical energy storage device according to claim 1;
a third electrical connection terminal and a fourth electrical connection terminal, capable of being connected to the load or to the recharging station; and
an energy converter capable of connecting the first and second electrical connection terminals to the third and the fourth electrical connection terminals, and arranged in order to adapt the form of the voltage between the first and second electrical connection terminals to the form of the voltage between the third and the fourth electrical connection terminals.

15. The power supply system according to claim 14, comprising a device, in which the control unit is arranged so that, within the voltage range comprised between the minimum operating voltage Uₘᵢₙ and the maximum operating voltage Uₘₐₓ, the energy converter has an efficiency greater than or equal to 95%.

16. The power supply system according to claim 14, also comprising:
an electrochemical energy storage device by charge transfer, capable of storing electrical energy between a fifth electrical connection terminal and a sixth electrical connection terminal; and
a controlled switch arranged in order to connect the third and fourth electrical connection terminals to the first and second electrical connection terminals of the reconfigurable electrical energy storage device or to the fifth and sixth electrical connection terminals of the electrochemical energy storage device by charge transfer.

17. The power supply system according to claim 14, also comprising:
a generator unit, capable of delivering electrical energy between a seventh electrical connection terminal and an eighth electrical connection terminal; and
a controlled switch arranged in order to connect the third and fourth electrical connection terminals to the first and second electrical connection terminals of the reconfigurable electrical energy storage device or to the seventh and eighth electrical connection terminals of the generator unit.

18. The power supply system according to claim 16, in which the controlled switch is arranged in order to connect the third and fourth electrical connection terminals to the first and second electrical connection terminals of the reconfigurable electrical energy storage device, to the fifth and sixth electrical connection terminals of the electrochemical energy storage device by charge transfer or to the seventh and eighth electrical connection terminals of the generator unit.

19. A vehicle comprising an electric power train and either a device according to claim 1, or a power supply system, the device or the power supply system being arranged in order to supply the power train with electrical energy.
